(19) United States
(12) Patent Application Publication
(10) Pub. No.: US 2005/0118470 A1
(43) Pub. Date: Jun. 2, 2005

(54) Fuel cell power generation device and fuel cell power generation method

(76) Inventors: Yasuhiro Harada, Isehara-shi (JP); Nobuo Shibuya, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/986,001

(22) Filed: Nov. 12, 2004

(30) Foreign Application Priority Data
Nov. 14, 2003 (JP) 2003-385426

(51) Int. Cl. H01M 8/04; H01M 8/10

(52) U.S. Cl. 429/22; 429/32; 429/23; 429/13

(57) ABSTRACT

A fuel cell power generating device comprises an electromotive unit which is formed by stacking of membrane electrode assembly which is enclosing an electrolyte film with an anode electrode and a cathode electrode and generates an electric power, a liquid fuel feed unit which supplies a liquid fuel to the anode electrode, a gas feed unit which supplies an oxidizer gas to the cathode electrode, a control unit which controls at least either the gas feed rate control for adjusting the feed rate of the oxidizer gas by the gas feed unit or the liquid fuel control for adjusting the feed rate of the liquid fuel by the liquid feed unit, at the time of satisfying either the condition in which the electromotive force of the electromotive unit is lower than a predetermined reference value, or the condition in which the predetermined time interval passes.

### CROSS-REFERENCE TO RELATED APPLICATIONS

This application is based upon and claims the benefit of priority from prior Japanese Patent Application No. 2003-385426, filed Nov. 14, 2003, the entire contents of which are incorporated herein by reference.

### BACKGROUND OF THE INVENTION

1. Field of the Invention

The present invention relates to a fuel cell power generation device and a fuel cell power generation method using liquid fuel such as methanol or an aqueous methanol solution as the fuel, and more particularly to a technology capable of obtaining a stable power generation output for a long period of time.

2. Description of the Related Art

A direct methanol fuel cell power generation device using methanol as fuel is designed to generate electric power by supplying an aqueous methanol solution to an anode electrode (fuel electrode) and air (oxygen) to a cathode electrode (oxidant electrode). By generating electric power, an oxidation reaction of methanol takes place at the anode electrode, and mainly carbon dioxide is produced. At the cathode electrode, mainly water is produced by reduction reaction of proton.

A cell composition of a general direct methanol fuel cell is characterized by a structure in which a membrane electrode assembly (MEA) composed of an anode electrode, a cathode electrode, and a solid polymer film electrolyte is enclosed from both sides by a fuel passage having a seal structure for maintaining electron conductivity and an airtight state by a fuel passage having electron conductivity and a seal structure for maintaining an airtight state. By laminating it in series electrically, a fuel cell stack capable of obtaining a desired output is produced, and it is assembled together with a liquid feed pump for supplying an aqueous methanol solution, an air feed pump for supplying air, an electronic circuit for controlling them, and auxiliary devices such as an auxiliary power supply, so that a fuel cell power generation device is composed (see, for example, Jan. Pat. Apple. KOKAI Publication Nos. 2003-032906, 2003-068342, and 2003-173807).

Such a direct methanol fuel cell power generation device is suitable to be incorporated as a power source of a small-sized electronic appliance, and it can be driven for a longer time, as compared with a secondary battery, without requiring recharging.

However, the above-mentioned direct methanol fuel cell power generation device has its own problems. That is, during continuous operation, carbon dioxide, water and other byproducts are produced by chemical reactions at both the anode electrode and cathode electrode, and the output is gradually lowered by their effects. Therefore, for continuous and efficient power generation, it is required to remove the carbon dioxide generated in the anode, water generated in the cathode, and byproducts efficiently.

Other causes of output drop in continuous operation include fuel not reaching a catalyst layer due to physical clogging of produced substances on a diffusion layer such as carbon paper having the catalyst layer for composing a membrane electrode assembly (MEA), and blocking of supply of fuel by direct deposits on the fuel passage. Byproducts (carbon monoxide, etc.) from the anode electrode are known to impede (poison) the catalyst function chemically.

Further, by prolonged continuous operation, not only output drop, but also decline of fuel efficiency and the like are induced, and by continuous operation for only several hours, ultimately, it is known that the power generation capacity is lowered to 90% or less of the initial level. Hence, the merit of continuous operation without recharging cannot be utilized sufficiently.

### BRIEF SUMMARY OF THE INVENTION

It is hence an object of the present invention to provide a fuel cell power generation device and a fuel cell power generation method capable of obtaining a stable power generation output for a long period of time.

To solve the problems and achieve the object, the fuel cell power generation device and fuel cell power generation method of the invention are composed as follows.

There are provided: an electromotive unit which is formed by stacking of membrane electrode assembly which is enclosing an electrolyte film with an anode electrode and a cathode electrode and generates an electric power; a liquid fuel feed unit which supplies a liquid fuel to the fuel electrode of the electromotive unit; a gas feed unit which supplies an oxidizer gas to the oxidant electrode of the electromotive unit; a control unit which controls at least either the gas feed rate control for adjusting the feed rate of the oxidizer gas by the gas feed unit or the liquid fuel control for adjusting the feed rate of the liquid fuel by the liquid feed unit, at the time of satisfying either the condition in which the electromotive force of the electromotive unit is lower than a predetermined reference value, or the condition in which the predetermined time interval passes and an output unit which delivers the electric power generated in the electromotive unit to the exterior.

According to the invention, a stable power generation output can be obtained for a long period of time.

### BRIEF DESCRIPTION OF THE SEVERAL VIEWS OF THE DRAWING

FIG. 1 is a block diagram of a schematic configuration of a fuel cell power generation device according to an embodiment of the present invention;

FIG. 2 is a block diagram of a DMFC control unit assembled in the fuel cell power generation device;

FIG. 3 is a flowchart of a refreshing operation of the fuel cell power generation device; and

FIG. 4 is a graph showing output fluctuations in the fuel cell power generation device.

### DETAILED DESCRIPTION OF THE INVENTION

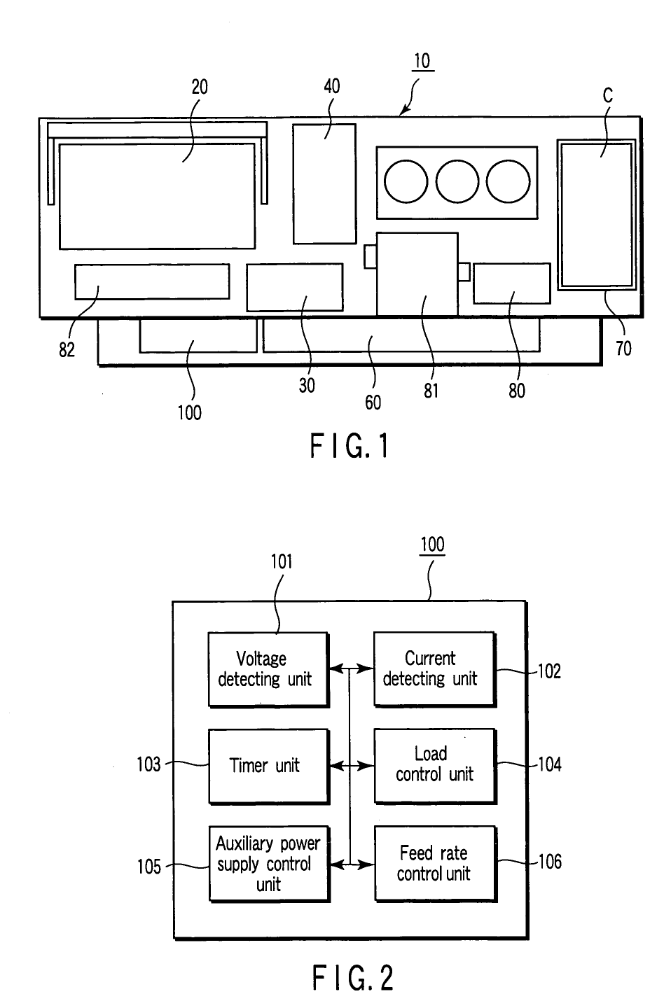

FIG. 1 is a block diagram of a schematic configuration of a fuel cell power generation device 10 according to an embodiment of the present invention. The fuel cell power generating device 10 comprises a DMFC electromotive device (electromotive unit) 20 for generating an electromotive force by chemical reaction between an aqueous methanol solution of fuel and air (oxygen) by way of an electrolyte film, a liquid feed pump (liquid fuel feed unit) 30 for supplying the aqueous methanol solution (liquid fuel) to the DMFC electromotive device 20, an air feed pump (gas feed unit) 40 for supplying air (oxidizer), a secondary battery unit (auxiliary power supply) 50, an output unit 60 for outputting from an output terminal (not shown), a cartridge unit 70 to which a fuel cartridge C described later is detachably connected, and a DMFC control unit (control unit) 100 for controlling power generation operation of the DMFC electromotive device 20 by controlling the action of these components. All components are assembled in one body, which composes a power supply unit pack. Further, in FIG. 1, reference numeral 80 is a liquid feed pump for an aqueous methanol solution, 81 is a mixing tank, and 82 is a heat exchanger.

The DMFC control unit 100 includes a voltage detecting unit 101 for monitoring the voltage outputted from the DMFC electromotive device 20, a current detecting unit 102 for detecting a load current, a timer unit 103 for counting the running time of the DMFC electromotive device 20, a load control unit 104 of the DMFC electromotive unit, an auxiliary power supply control unit 105 of the secondary battery unit 50, and a feed rate control unit 106 for variably controlling the supply capacity (flow rate) of the liquid feed pump 30 and air feed pump 40. The fuel cartridge C is filled with an aqueous methanol solution.

The fuel cell power generation device 10 having such a configuration operates as follows. The electric power outputted from the fuel cell power generation device 10 is operated with the DMFC electromotive device 20 as the main power supply and the secondary battery unit 50 as the auxiliary power supply. The operation consists of four modes: a start mode, a stationary operation mode, an output recovery mode, and an end mode.

First, the start mode will be explained. To begin with, the fuel cartridge C is loaded into the cartridge unit 70. Before electromotive reaction of the DMFC electromotive device 20, since its electromotive force is zero, the DMFC control unit 100 is driven by the electric power from the secondary battery unit 50, and the liquid feed pump 30 and air feed pump 40 are put into operation. An aqueous methanol solution is supplied into the DMFC electromotive device 20 through the liquid feed pump 30. As the oxidizer, air (oxygen) is supplied by taking in fresh air into the DMFC electromotive device 20 by the air feed pump 40. In the DMFC electromotive device 20, reaction starts, and electric power is generated. Initially, since the output from the DMFC electromotive device 20 is unstable, output is produced from the output unit 60 mainly by the secondary battery unit 50.

Second, the stationary operation mode will be explained. In the stationary operation mode, as far as the load is constant or changes slightly, the aqueous methanol solution and air are supplied at a predetermined feed rate from the liquid feed pump 30 and air feed pump 40 into the DMFC electromotive device 20, and voltage and current are produced in a predetermined range.

On the other hand, if the load changes suddenly, there is a time lag until the output from the DMFC electromotive device 20 follows up the load, thus the voltage is unstable. The secondary battery unit 50 described above is used as the auxiliary power supply for supplying electric power to the DMFC control unit 100, in place of the DMFC electromotive device 20, when the operation is unstable in the DMFC electromotive device 20. The secondary battery unit 50 also plays a role of stabilizing the output of the fuel cell power generation device 10 by compensating for such unstable voltage phenomenon when a direct type methanol fuel cell is applied as a power supply for a small-sized electronic appliance.

Third, the output recovery mode will be explained. After a certain time in the stationary operation mode, reaction products are accumulated in the DMFC electromotive device 20. Reaction products are gathered and collected on the passage plates for composing the DMFC electromotive device 20 and a surface of membrane electrode assembly as mentioned above, and whereby supply of the aqueous methanol solution and air is blocked, so that the output is lowered. For removing these reaction products efficiently and refreshing, the load applied to the DMFC electromotive device 20 is released or decreased, and production of reaction products is suppressed or eliminated.

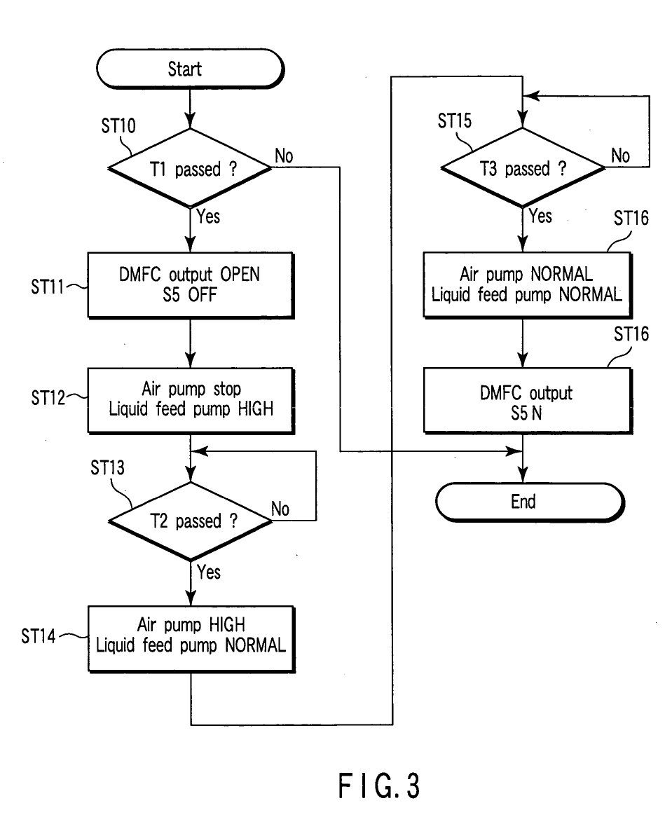

A specific operation will be explained by referring to a control flowchart in FIG. 3. Starting from a specific reference time, it is determined whether or not a predetermined time T1 has passed from the reference time (ST10). The operation is over if the predetermined time T1 has not passed. When the predetermined time T1 has been passed, a refresh operation (first mode) is started, that is, removal of reaction products is started. First, the load of the DMFC electromotive device 20 is released, and generation of carbon dioxide and byproducts in the anode electrode is arrested (ST11). At the same time, electric power is changed over to be supplied from the secondary battery unit 50, and it is controlled so that the output of the fuel cell power generation device 10 does not decline below the rating. By stopping or decreasing the air feed pump 40, the feed rate of the liquid feed pump 30 is raised to the maximum (ST12). As a result, the carbon dioxide and byproducts accumulated at the anode electrode are discharged.

After a predetermined time T2 necessary for discharging the carbon dioxide and byproducts has passed (ST13), the feed rate of the air feed pump 40 is raised to the maximum, while the feed rate of the liquid feed pump 30 is returned to the ordinary level (ST14). As a result, water accumulated at the cathode electrode is discharged.

After a predetermined time T3 necessary for discharging the water has passed (ST15), the feed rate of both the liquid feed pump 30 and air feed pump 40 is returned to the stationary state (ST16).

Finally, by the DMFC control unit 100, the voltage of the DMFC electromotive device 20 is detected. When elevation to a predetermined voltage is confirmed, the load of the DMFC electromotive device 20 is changed over from the secondary battery unit 50 to the DMFC electromotive device 20, and the stationary operation mode is resumed (ST17).

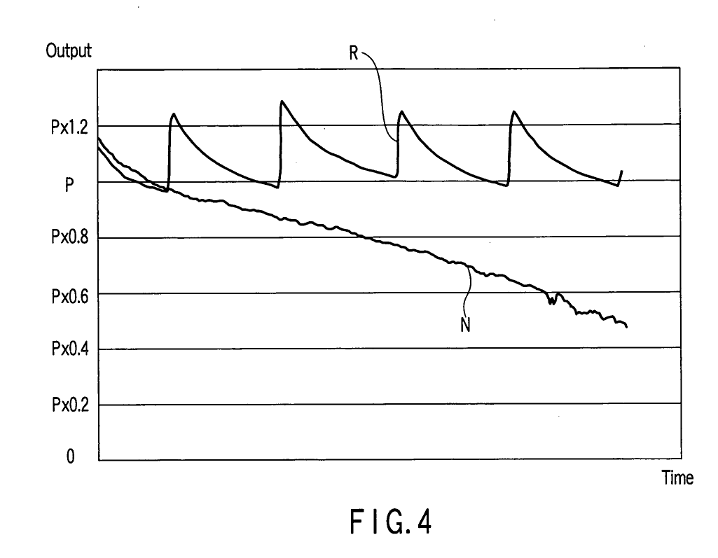

FIG. 4 is a graph showing output characteristics in operation of the fuel cell power generation device 10. The abscissa axis denotes the time and the ordinates axis represents the output. When generating electric power continuously by operating the fuel cell power generation device without actuating the function of reaction product removal operation of the invention, as indicated by N in FIG. 4, the output declines with the passing of the time. When the reaction product is removed by actuating the mechanism of the above-mentioned embodiment, as indicated by R in FIG. 4, the output of the fuel cell power generation device is maintained, not becoming lower than the lower limit output of P×0.8.

In this control flow, output decline is prevented by refreshing at a predetermined time interval. However, the refreshing operation may be performed during the stationary operation mode by detecting the output decline of the DMFC electromotive device 20 by the voltage detecting unit 101 and current detecting unit 102. More specifically, instead of the condition of starting (ST10) the refreshing operation (ST11 to ST16) when the predetermined time T1 has passed, supposing the rated output of the DMFC electromotive device 20 to be P(W), the lower limit output P′(W) of the fuel cell is defined in a range of P×0.6≦P′≦P×1.3, and when decline from the lower limit output P′(W) is detected, the refreshing operation can be started. More preferably, P′ should be about P×0.8.

The refreshing operation is not limited to the first mode mentioned above, but various operations are possible such as a second mode to a seventeenth mode as shown in Table 1. In Table 1, air DN is a control for decreasing the feed rate of air, air UP is a control for increasing the feed rate of air, fuel DN is a control for decreasing the feed rate of the aqueous methanol solution, fuel UP is a control for increasing the feed rate of the aqueous methanol solution, and T is a predetermined time determined in each mode.

TABLE 1

| Operation | | | | | | |
|---|---|---|---|---|---|---|
| mode | Operation 1 | Operation 2 | Operation 3 | Operation 4 | Operation 5 | Operation 6 |
| 1 | Air DN | τ pass | Air UP | | | |
| 2 | Air DN | Fuel UP | τ pass | Air UP | Fuel DN | |
| 3 | Fuel UP | Air DN | τ pass | Air UP | Fuel DN | |
| 4 | Fuel DN | Air DN | τ pass | Fuel UP | Air UP | |
| 5 | Air DN | Fuel DN | τ pass | Fuel UP | Air UP | |
| 6 | Load cut-off | Air DN | τ pass | Air UP | | |
| 7 | Load cut-off | Air DN | Fuel UP | τ pass | Air UP | Fuel DN |
| 8 | Load cut-off | Fuel UP | Air DN | τ pass | Air UP | Fuel DN |
| 9 | Load cut-off | Fuel DN | Air DN | τ pass | Fuel UP | Air UP |
| 10 | Load cut-off | Air DN | Fuel DN | τ pass | Fuel UP | Air UP |
| 11 | Air DN | Load cut-off | τ pass | Air UP | | |
| 12 | Air DN | Load cut-off | Fuel UP | τ pass | Air UP | Fuel DN |
| 13 | Fuel UP | Air DN | Load cut-off | τ pass | Air UP | Fuel DN |
| 14 | Fuel DN | Air DN | Load cut-off | τ pass | Fuel UP | Air UP |
| 15 | Air DN | Load cut-off | Fuel ON | τ pass | Fuel UP | Air UP |
| 16 | Fuel DN | Load cut-off | Air DN | τ pass | Fuel UP | Air UP |
| 17 | Air DN | Fuel DN | Load cut-off | τ pass | Fuel UP | Air UP |

Fourth, the end mode will be explained. In the end mode, the load of the DMFC electromotive device 20 is cut off, and gas feed rate decrease control for decreasing the feed rate of air and liquid fuel increase control for increasing the feed rate of the aqueous methanol solution are performed, whereby it is intended to remove reaction products collected on the passage plates composing the DMFC electromotive device 20 and the surface of the membrane electrode assembly. Thereafter, supply of the liquid feed pump 30 and air feed pump 40 is stopped, and electromotive operation is completed.

Another process may be possible for the end mode. For example, after cutting off the load of the DMFC electromotive device 20, for a predetermined period of time, by increasing at least one of the feed rate of air and the feed rate of the aqueous methanol solution, preferably increasing both simultaneously, it is also possible to remove efficiently reaction products collected on the passage plates of the liquid fuel electrode and oxidant electrode composing the DMFC electromotive device 20 and the surface of the membrane electrode assembly.

Further, in the operation mode, the operation can be finished without cutting off the load of the DMFC electromotive device 20 until at least one of the liquid feed pump 30 and air feed pump 40 stops supply. Preferably, after stopping of the liquid feed pump 30, the air feed pump 40 should be stopped, and the load of the DMFC electromotive device 20 should be cut off. Thus, by keeping connection of the load until the end of operation, the liquid fuel or oxidizer remaining in the passage can be removed by electrochemical reaction, so that deterioration or poisoning of the electromotive member can be prevented.

Such an operation method is also applicable in the output recovery mode explained in the embodiment. That is, the load can be applied continuously until the supply is stopped when stopping supply of the liquid fuel or oxidizer.

According to the fuel cell power generation device 10 as described herein, by detecting the predetermined time interval or output situation of the DMFC electromotive device 20, the refresh operation can be executed, that is, the output decline of the fuel cell can be recovered by the mechanism of removing the reaction products, so that a stable output can be obtained for a long period of time.

Further, when removing reaction products, by releasing or decreasing the load of the fuel cell electromotive unit, they are removed after setting up a state of suppressing newly produced reaction products, an effective removal effect is obtained even if there is no sufficient capacity in portable fuel cells, various pumps and the like.

In this fuel cell power generating device, mainly the direct methanol type fuel cell power generating device is explained, but the invention may be applied to any other fuel cell power generating device using air as a reaction substance. Since production of water due to the reaction of an air electrode is unavoidable, in a fuel cell of a low operating temperature, in particular, adverse effects due to clogging or collection of water cannot be avoided. For example, it can be applied to a solid polymer fuel cell using hydrogen as fuel, or a fuel cell using dimethyl ether, boron halide or the like as fuel.

In the diagram, the auxiliary power supply is integrally assembled in the device, but not limited to this example, the auxiliary power supply may be provided outside of the device. Usable examples of the auxiliary power supply include various secondary batteries, chemical cells such as primary batteries, physical cells such as solar cells and thermal cells, and capacitors such as capacitors of large capacity.

Instead of controlling the capacity of the pump main body, valve mechanisms such as solenoid valves may be provided in the piping of the pumps, and by controlling (opening and closing) during pump supply operation, the capacity of liquid feed or air feed may be varied or pulsated. Therefore, similar effects are obtained when pulsating the supply from the air feed pump.

Moreover, in the embodiment, the fuel cell power generating device of portable type is mainly described, but it is also applicable to the evaluation apparatus or production process for the fuel cell device. More specifically, of the elements for composing the fuel cell, it can be applied to all devices requiring continuous operation, such as continuous trial run and other element technology evaluation of the power generation stack, evaluation apparatus for quality control in the production line, and the like. For example, the membrane electrode assembly (MEA) of the fuel cell can be applied to an initial power generation process (running-in operation) called conditioning after manufacture. This process is important for extracting the initial performance of the MEA, and by applying the operation method of the embodiment, conditioning can be performed more efficiently.

The invention is not limited to the embodiment alone, but may be embodied in various forms without departing from the spirit or essential characteristics thereof. Further, by properly combining plural constituent elements disclosed in the embodiment, the invention may be realized in various aspects. For example, several constituent elements may be eliminated from all constituent elements shown in the embodiment. Further, various constituent elements in the embodiment may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A fuel cell power generating device comprising:
an electromotive unit which is formed by stacking of membrane electrode assembly which is enclosing an electrolyte film with an anode electrode and a cathode electrode and generates an electric power;
a liquid fuel feed unit which supplies a liquid fuel to the anode electrode of the electromotive unit;
a gas feed unit which supplies an oxidizer gas to the cathode electrode of the electromotive unit;
a control unit which controls at least either the gas feed rate control for adjusting the feed rate of the oxidizer gas by the gas feed unit or the liquid fuel control for adjusting the feed rate of the liquid fuel by the liquid feed unit, at the time of satisfying either the condition in which the electromotive force of the electromotive unit is lower than a predetermined reference value, or the condition in which the predetermined time interval passes; and
an output unit which delivers the electric power generated in the electromotive unit to the exterior.

2. The fuel cell power generating device according to claim 1, further comprising:
an auxiliary power supply unit which supplies electric power to the liquid fuel feed unit, the gas feed unit, the control unit, and the output unit.

3. The fuel cell power generating device according to claim 1,
wherein the control unit controls either the gas feed rate control for adjusting the feed rate of the oxidizer gas or the liquid fuel control for adjusting the feed rate of the liquid fuel, at the time of finishing the operation of the electromotive unit.

4. The fuel cell power generating device according to claim 3,
wherein the control unit stops supply of the oxidizer gas by the gas feed unit after stopping supply of the liquid fuel by the liquid fuel feed unit.

5. The fuel cell power generating device according to claim 1,
wherein the control unit cuts off a load for separating connection with the load before the gas feed rate control or liquid feed control is performed.

6. The fuel cell power generating device according to claim 1,
wherein the control unit decreases the feed rate of the oxidizer gas, and increases the feed rate of the oxidizer gas after a predetermined time has elapsed.

7. The fuel cell power generating device according to claim 1,
wherein the control unit decreases the feed rate of the oxidizer gas, increases the feed rate of the liquid fuel, and after a predetermined time has elapsed, increases the feed rate of the oxidizer gas and decreases the feed rate of the liquid fuel.

8. The fuel cell power generating device according to claim 1,
wherein the control unit increases the feed rate of the liquid fuel, decreases the feed rate of the oxidizer gas, and after a predetermined time has elapsed, increases the feed rate of the oxidizer gas and decreases the feed rate of the liquid fuel.

9. The fuel cell power generating device according to claim 1,
wherein the control unit decreases the feed rate of the liquid fuel, decreases the feed rate of the oxidizer gas, and after a predetermined time has elapsed, increases the feed rate of the liquid fuel and increases the feed rate of the oxidizer gas.

10. The fuel cell power generating device according to claim 1,
wherein the control unit decreases the feed rate of the oxidizer gas, decreases the feed rate of the liquid fuel, and after a predetermined time has elapsed, increases the feed rate of the liquid fuel and increases the feed rate of the oxidizer gas.

11. The fuel cell power generating device according to claim 1,
wherein the control unit decreases the feed rate of the oxidizer gas, cuts off a load, and after a predetermined time has elapsed, increases the feed rate of the oxidizer gas.

12. The fuel cell power generating device according to claim 1,
wherein the control unit decreases the feed rate of the oxidizer gas, cuts off a load, increases the feed rate of the liquid fuel, and after a predetermined time has elapsed, increases the feed rate of the oxidizer gas, and decreases the feed rate of the liquid fuel.

13. The fuel cell power generating device according to claim 1,
wherein the control unit increases the feed rate of the liquid fuel, decreases the feed rate of the oxidizer gas, cuts off a load, and after a predetermined time has elapsed, increases the feed rate of the oxidizer gas, and decreases the feed rate of the liquid fuel.

14. The fuel cell power generating device according to claim 1,
wherein the control unit decreases the feed rate of the liquid fuel, decreases the feed rate of the oxidizer gas, cuts off a load, and after a predetermined time has elapsed, increases the feed rate of the liquid fuel, and decreases the feed rate of the oxidizer gas.

15. The fuel cell power generating device according to claim 1,
wherein the control unit decreases the feed rate of the oxidizer gas, cuts off a load, decreases the feed rate of the liquid fuel, and after a predetermined time has elapsed, increases the feed rate of the liquid fuel, and increases the feed rate of the oxidizer gas.

16. The fuel cell power generating device according to claim 1,
wherein the control unit decreases the feed rate of the liquid fuel, cuts off a load, decreases the feed rate of the oxidizer gas, and after a predetermined time has elapsed, increases the feed rate of the liquid fuel, and increases the feed rate of the oxidizer gas.

17. The fuel cell power generating device according to claim 1,
wherein the control unit decreases the feed rate of the oxidizer gas, decreases the feed rate of the liquid fuel, cuts off a load, and after a predetermined time has elapsed, increases the feed rate of the liquid fuel, and increases the feed rate of the oxidizer gas.

18. A fuel cell power generating method comprising:
supplying liquid fuel to an anode electrode of an electromotive unit formed by stacking of membrane electrode assembly constituted by enclosing an electrolyte film with the anode electrode and an cathode electrode, and supplying oxidizer gas to the cathode electrode of the electromotive unit, thereby generating an electromotive force in the electromotive unit;
producing the generated electromotive force outside through an output terminal; and
controlling at least either the gas feed rate decreasing control for decreasing the feed rate of the oxidizer gas or the liquid fuel increasing control for increasing the feed rate of the liquid fuel, at the time of satisfying either the condition in which the electromotive force of the electromotive unit is lower than a predetermined reference value, or the condition in which a predetermined time interval passes.

19. The fuel cell power generating method according to claim 18,
wherein an electric power is supplied to the output terminal from an auxiliary power source when the generated electromotive force is lower than a predetermined value.

20. The fuel cell power generating method according to claim 18,
wherein either the gas feed rate control for adjusting the feed rate of the oxidizer gas or the liquid fuel control for adjusting the feed rate of the liquid fuel is executed, at the time of terminating the operation of the electromotive unit.
